(19) United States
(12) Patent Application Publication
(10) Pub. No.: US 2012/0284116 A1
(43) Pub. Date: Nov. 8, 2012

(54) SYSTEMS AND METHODS FOR INCENTIVIZED NETWORK ADVERTISING AND DATA AGGREGATION

(76) Inventors: John C. Herman, Atlanta, GA (US); Cary Anthony Jardin, Poway, CA (US)

(21) Appl. No.: 13/462,099

(22) Filed: May 2, 2012

Related U.S. Application Data
(60) Provisional application No. 61/481,402, filed on May 2, 2011.

(51) Int. Cl. G06Q 30/02

(52) U.S. Cl. 705/14.49

(57) ABSTRACT

The embodiments of the present invention generally relate to systems, methods, and computer program products for incentivized network advertising and data aggregation. One embodiment, for example, provides a network advertising program that rewards consumer participation. In one aspect, the consumer can select topics for the advertisements that are provided to—and that generate rewards for—the consumer. Another embodiment provides methods for aggregating transactional data associated with consumer products, wherein rewards are provided based on advertisements presented to the consumer in view of provided sales transaction data.

### CROSS-REFERENCE TO RELATED APPLICATIONS

This application claims priority to U.S. Provisional Application Ser. No. 61/481,402, entitled “METHODS AND SYSTEMS FOR PRODUCT AND SERVICE DATA AGGREGATION,” filed May 2, 2011, which is herein incorporated by reference in its entirety.

### BACKGROUND OF THE INVENTION

Conventional systems for Internet advertising and data aggregation have several disadvantages for consumers. For example, conventional Internet advertising systems involve tracking consumers, surreptitiously monitoring consumers, tricking consumers into exposing information, and similar methods to collect consumer data, all of which is then used to try to predict consumer behavior and determine targeted advertisements. These methods raise serious privacy concerns and therefore lead to a lack of consumer trust and participation.

Moreover, the consumer is often a passive participant in the selection of advertisements that are presented to him or her, making conventional advertising systems not only invasive, but often ineffective. Further, these systems may provide no incentive (and may in fact provide a disincentive) for a consumer to actually respond to an Internet advertisement, such as by clicking on the advertisement and making a subsequent product purchase or recommendation.

Accordingly, there is a need in the art for systems, methods, and computer program products that provide a trusted platform for the collection of consumer and product information, for the selection and presentation of advertisements and product information, and for incentivized consumer participation.

### SUMMARY OF THE INVENTION

The embodiments of the present invention generally relate to systems, methods, and computer program products for incentivized network advertising and data aggregation. A first set of embodiments provide methods, computer program products, and systems for aggregating transactional data associated with consumer products. Another set of embodiments provide methods, systems, and computer program products for providing a network advertising program that rewards consumer participation.

A first embodiment of the present invention provides a computer-implemented method for aggregating transactional data associated with consumer products. The method first comprises the step of providing a web-based interface for displaying transactional data for a plurality of products. Second, an account can be stored for each of a plurality of registered users, wherein the plurality of users includes at least a first user associated with a first account. Third, a transactional data for a first product can be received through the web-based interface and from the first user. Fourth, a first user account can store an association between the transactional data for the first product and the first user. Fifth, an advertisement can be determined using at least the transactional data for the first product. Sixth, the advertisement can be provided for display on the web-based interface, such as in a web browser. Seventh, a reward can be calculated for the first user based on displays of and/or interactions with the advertisement on the web-based interface.

Another embodiment of the present invention provides a computer-readable non-transitory storage medium with computer executable instructions embodied thereon for aggregating transactional data associated with consumer products. First, a web-based interface is provided for displaying transactional data for a plurality of products. Second, an account can be stored for each of a plurality of registered users, wherein the plurality of users includes at least a first user associated with a first account. Third, a transactional data for a first product can be received through the web-based interface and from the first user. Fourth, a first user account can store an association between the transactional data for the first product and the first user. Fifth, an advertisement can be determined using at least the transactional data for the first product. Sixth, the advertisement can be provided for display on the web-based interface, such as in a web browser. Seventh, a reward can be calculated for the first user based on displays of and/or interactions with the advertisement on the web-based interface.

Further embodiments of the present invention relate to methods, computer program products, and systems for providing novel network advertising programs that reward consumer participation. A first such embodiment comprises a computer-implemented method for providing a novel network advertising program that rewards consumer participation. First, in the method of one computer-implemented embodiment, a participant account can be stored, with the participant account including a unique identifier and an advertising profile. Second, network content can be provided to the participant based on a request for content. Third, an advertisement can be provided to the participant based on the advertising profile. Fourth, an advertising history can be stored for the participant that includes an identifier associated with the advertisement. Fifth, a reward can be calculated for the participant using the advertising history.

Additional embodiments of the present invention provide a computer-readable non-transitory storage medium with computer executable instructions embodied thereon for providing a novel network advertising program that reward consumer participation, first comprising storing a participant account, with the participant account including a unique identifier and an advertising profile. Second, network content can be provided to the participant based on a request for content. Third, an advertisement can be provided to the participant based on the advertising profile. Fourth, an advertising history can be stored for the participant that includes an identifier associated with the advertisement. Fifth, a reward can be calculated for the participant using the advertising history.

Another embodiment of the present invention provides a method for a network advertising program that rewards a participant. First, a participant can provide information over the network to create a participant account. The participant account can be associated with one or more of a unique identifier, an advertising profile, and an advertising history, and can be stored at an account server. Second, the participant can use a client device, such as a personal computer, smart-phone, or tablet, for example, to issue a request for content over the network, such as a request for a web page. Third, the client device can receive the requested content over the network. Fourth, at least a portion of the requested content can be rendered on the client device, such as by displaying the requested content in a web browser and/or application on the client device. Fifth, the client device can receive an advertisement, and the advertisement can be selected using at least one of the request for content and the advertising history. Sixth, the client device can render at least a portion of the advertisement, such as by displaying the advertisement. The requested content and the advertisement can be simultaneously rendered, and/or rendered using the same screen or display, such as by being simultaneously rendered in the same web browser or application window. Finally, the participant can receive a reward, for example, based on at least one of the advertising history, the advertisement, and the participant's interaction with the advertisement (such as click-through and/or subsequent product purchase). The participant can then receive a reward and a notification of the issued reward on the client device.

A further embodiment of the present invention provides a computer-readable non-transitory storage medium with computer executable instructions embodied thereon for a network advertising program that rewards a participant. First, a participant can provide information over the network to create a participant account. The participant account can be associated with one or more of a unique identifier, an advertising profile, and an advertising history, and can be stored at an account server. Second, the participant can use a client device, such as a personal computer, smart-phone, or tablet, for example, to issue a request for content over the network, such as a request for a web page. Third, the client device can receive the requested content over the network. Fourth, at least a portion of the requested content can be rendered on the client device, such as by displaying the requested content in a web browser and/or application on the client device. Fifth, the client device can receive an advertisement, and the advertisement can be selected using at least one of the request for content and the advertising history. Sixth, the client device can render at least a portion of the advertisement. The requested content and the advertisement can be simultaneously rendered, and/or rendered using the same screen, such as by being simultaneously rendered in the same web browser or application window. Finally, the participant can receive a reward, for example, based on at least one of the advertising history, the advertisement, and the participant's interaction with the advertisement (such as click-through and/or subsequent product purchase). The participant can then receive a reward and a notification of the issued reward on the client device.

Additional embodiments of the present invention provide systems that provide a network advertising program that rewards consumer participation. In one such embodiment, the system can comprise logical and/or physical servers, including a content server, an advertising server, and an account server, each communicatively coupled to network, such as the Internet. The content server can be configured, such as by using a programmed processor, to provide content to a participant based on a request for content. The advertising server can be configured, such as by using a programmed processor, to provide an advertisement to the participant based on an advertising profile. The account server can be configured, such as by using a programmed processor, to perform a variety of tasks, including storing a participant account that includes a unique identifier and the advertising profile, storing an advertising history for the participant that includes an identifier associated with the advertisement, and/or calculating a reward to the participant using the advertising history.

Of course, a person of ordinary skill in the art will understand that embodiments relating to network advertising can also be used or combined, in whole or in part, with embodiments that aggregate transactional data associated with consumer products. By way of example, the request for content can comprise a request for product information, and the web-based interface that displays the requested product information can also simultaneously display product-related advertisements that generate rewards for the participant and/or for the participant's network contacts.

Unless otherwise expressly stated, it is in no way intended that any embodiment set forth herein be construed as requiring that its steps or process, if any, be performed in a specific order. This holds for any possible non-express basis for interpretation, including matters of logic with respect to arrangement of steps or operational flow, plain meaning derived from grammatical organization or punctuation, or the number or type of embodiments described in the specification.

### BRIEF DESCRIPTION OF THE DRAWINGS

The accompanying drawings, which are incorporated in and constitute part of this specification, illustrate embodiments of the invention, and together with the description, serve to explain the principles of the invention. The embodiments described in the drawings and specification in no way limit or define the scope of the present invention.

FIG. 1 is an exemplary block diagram of a system for tracking, displaying, and maintaining product listing information.

FIG. 2 is a flow chart of exemplary steps for returning requested product data to a user.

FIG.3 is a flow chart of exemplary steps for determining and disbursing revenue to users.

FIG. 4 is an exemplary illustration of a webpage displaying a user created product listing page.

FIG. 5 is a flow chart of exemplary steps for returning requested product data to a user.

FIG. 6 is a flow chart of exemplary steps for providing a network advertising program that rewards consumer participation.

FIG. 7 is a flow chart of exemplary steps for a network advertising program that rewards consumer participation.

FIG. 8 shows an exemplary system that provides a network advertising program that rewards consumer participation.

The present invention has been illustrated in relation to embodiments which are intended in all respects to be illustrative rather than restrictive. Those skilled in the art will realize that the embodiments of the present invention are capable of many modifications and variations without departing from the scope of the present invention.

### DETAILED DESCRIPTION OF THE INVENTION

Before the present methods, systems, and program products are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable non-transient or non-volatile computer-readable storage medium may be utilized including hard disks, CD-ROMs, optical storage devices, or magnetic storage devices.

Embodiments of the methods and systems are described below with reference to block diagrams and flowchart illustrations of methods, systems, and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

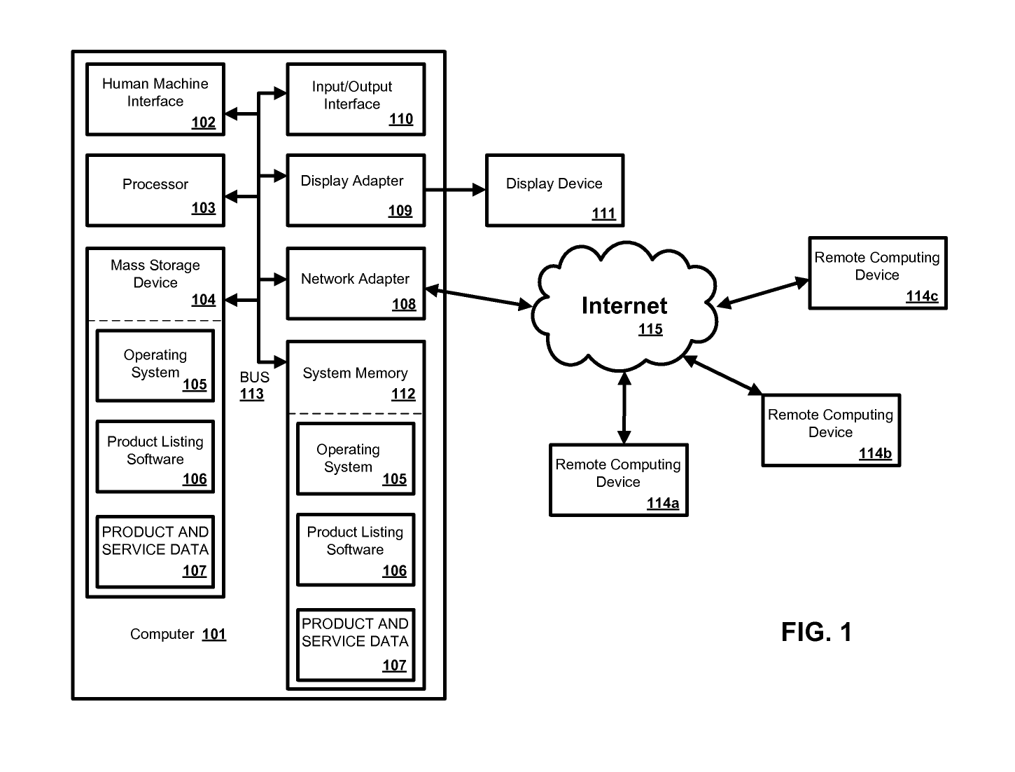

One skilled in the art will appreciate that provided herein is a functional description and that the respective functions can be performed by software, hardware, or a combination of software and hardware. For example, the systems and methods can comprise the product listing software 106 as illustrated in FIG. 1 and described below. In one exemplary embodiment, the units can comprise a computer 101 as illustrated in FIG. 1 and described below.

FIG. 1 is a block diagram illustrating an exemplary operating environment for performing the disclosed systems and methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, hand-held devices, cell phones, smart phones, tablets, e-book readers, set-top boxes, smart TVs, and multiprocessor systems. Additional examples comprise programmable consumer electronics, network PCs, minicomputers, mainframe computers, distributed computing environments that comprise any of the above systems or devices, and the like. Any of the above-referenced computing devices can comprise a server and/or a client device in embodiments of the present invention.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, product listing software 106, product data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as product data 107 and/or program modules such as operating system 105 and product listing software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and product listing software 106. Each of the operating system 105 and product listing software 106 (or some combination thereof) can comprise elements of the programming and the product listing software 106. Product data 107 can also be stored on the mass storage device 104. Product data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of product listing software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

FIG. 1 shows a consumer-oriented system for organizing and displaying user-generated content on specific products for the benefit of consumers. In one exemplary embodiment users can employ remote computing devices 114a,b,c to access the Internet 115. Users can then access the system, search for a specific product, review the product's information, and add or edit information about the product. Examples of products include consumer goods such as consumer electronics, appliances, tools, home furnishings, automobiles, and any other products a consumer might wish to research. Information about each product is displayed within individual product listing pages and can be stored in product data 107. Product listing pages can include different types of information such as pricing, product reviews, product experiences, retail locations, instructional videos, maintenance instructions, and any other information users add. In an aspect, automated searches of other websites and web services can be used to obtain information regarding products and services. For example, data can be obtained from EBAY, TWITTER, YELP!, FACEBOOK, GMAIL, GOOGLE, YAHOO, AMAZON, TUMBLR, LINKEDIN, OUTLOOK, NETFLIX, ROKU, and the like.

Additionally, specific product listing pages, or portions thereof, can be purchased by users that wish to publish information about specific products. For example, a user could be a manufacturer who purchases product listing pages for the products the manufacturer sells. Purchasing product listing pages for different products would allow the manufacturer to distribute advertising, information about product recalls, how-to-instructions, and any other information that might be useful to consumers. A manufacturer created product listing page can be linked to one or more pages for the same or similar product or service created by a consumer.

In an aspect, location based information can be included in the product information. Such location based information can include, but is not limited to, GPS coordinates, addresses, cities, states, zip codes, etc. of locations where products can be purchased or where pricing information is derived. For example, location based information can be provided automatically based on the user's location when entering product information, as determined by user profile, IP address geo-location, or GPS-type determinations utilizing hand held devices such as smart phones.

In one embodiment, a user can create an account by registering their personal information before being able to add, edit, or view any user generated content. Creating an account by registering personal information with the system can comprise having the user provide a unique username, an email address, a mailing address, a phone number, and any other contact information that can be used to identify the specific user.

In another embodiment, a user can create an account by using their existing accounts with other services to automatically create an account in the system. For example, a user can automatically create an account by implementing FACEBOOK's API or through TWITTER's API. Additionally, when a user automatically creates an account, the user can elect for the system to transmit the user's current and future activity to the other services. For example, a user can elect to edit a product listing page and have the edited information or activity published to the user's FACEBOOK profile after the user automatically creates an account by using the user's FACEBOOK profile to register with the system. Consumer and product data can be obtained through connections of this type to other websites and web services.

To encourage user participation, the system can implement a method for disbursing rewards by tracking data to determine an interest level in each product listing page. The tracked data can be used to determine a reward for users that generate a sufficient level of interest in the products. The system can determine whether a sufficient level of interest has been generated by tracking user activity and monitoring a predetermined interest level threshold for each product listing page. The system can determine the level of interest by monitoring and tracking which users create product listing pages that generate the most interest. For example, the system can monitor a product listing page to track different types of data, which can include: which user created the listing; the number of views per minute, day, week, month, or any measure of time; the number of outside websites that link to the specific product listing page; the number of other users who rate the listing; a rating other users assign the product listing page; and any other method of data tracking used to determine consumer interest. By utilizing different methods of measuring interest, the system can determine which products are the most popular and what aspects about particular products or services are of most interest to consumers (e.g. price, geography, availability, and other features).

In another aspect, users can be rewarded for generating a sufficient level of interest on pages created by other users. The system can determine whether a sufficient level of interest has been generated by tracking user activity and monitoring a predetermined interest level threshold for each product listing page. For example, if user A creates a product listing page for an APPLE IPHONE and user B adds content to user A's APPLE IPHONE product listing page, and user B's addition generates a sufficient level of interest, then user B can be rewarded for generating a level of interest that surpasses the predetermined interest level threshold for user A's APPLE IPHONE product listing page.

The system can be configured to disburse advertisement revenue after determining that the interest level threshold for each product listing page has been surpassed. Disbursing advertisement revenue and determining an interest level threshold for each product listing page can occur at set time intervals, when a specified user page-view count level is met, or any other predetermined time. Additionally, the interest level threshold can be adjusted for each product according to the size of the consuming public, the time of year (e.g., holiday shopping periods vs. normal shopping periods), the number of days the product has been on the market, or any other variable that can cause interest levels to vary.

In one embodiment, the system can be configured to monitor a specific product listing page for the number of times users visit the specific product listing page and to determine a total amount of advertisement revenue that each user's visit generates (or measure other industry-specific metrics by which advertising revenues are determined). The system can disburse a predetermined amount of the advertisement revenue to a user who generated sufficient interest in the specific product listing page to surpass the interest level threshold for the specific product listing page. For example, the system could be configured to disburse 25% of the system's total advertisement revenue for a user's SONY PLAYSTATION 3 product listing page after the system determines that the user's SONY PLAYSTATION 3 product listing page has generated significant interest. In another example, an interest level threshold can be set during the holiday shopping season so that a user's SONY PLAYSTATION 3 product listing page would need to be viewed 1000 times before the system determines that the interest level threshold has been met. Users can be motivated to create and update popular consumer goods in a real time manner to attract attention from other users, thereby earning additional advertisement revenue. Thus, the system can create on-demand product information from users who are familiar with the products. Pages can also be set so that at any given time there is a single user who is earning a set portion of revenues as result of having the most interest generated for a particular page based on that user's post or postings.

In another embodiment, the system can implement a rating system that further encourages the real-time nature of the system by determining how “fresh” the information is. Determining how “fresh” the information is can comprise determining which product listing pages are popular by monitoring different data sets. The different data sets can include the date the product listing pages were created, the number of days the product has been available for consumer purchase, whether the product has been replaced by a newer model, how recently the product listing pages have been edited or updated by a user, the frequency with which users view the product listing pages, the frequency with which outside websites link to the product listing pages, and any other data that would be useful in determining the product listing page's popularity. Additionally, determining how “fresh” the information is can comprise monitoring user input on the quality of the page listing. For example, monitoring user input on the quality of the page listing can comprise users voting on the quality of the information in the product listing page or tracking the frequency with which users recommend the product listing page to other users. The freshness of a particular past can be calculated by an algorithm taking into account these metrics and promoted or demoted on a particular product page as a result of the calculation.

Further embodiments provide methods for degrading product listing pages. Each individual post can automatically be ranked based on relevance and interest. In an aspect, rank can equal one or more of a topic relevance score plus hits plus comments plus replies plus rating of individual post based on user feedback. Each post can then automatically be degraded based on a formula such as: decay=rank−(time since post*number of other higher ranked posts). The degradation method can be relative to other posts on the particular topic—as score decreases, the post would fall down the list automatically such that the first page on posts (dashboard posts) would be the highest scorers. The degradation methods can generate consumer data such as products and/or services that rank the lowest (least interesting) in addition to the highest (most interesting). In an aspect, consumers can be polled for additional information to determine why a product and/or service attained a particular ranking, high or low.

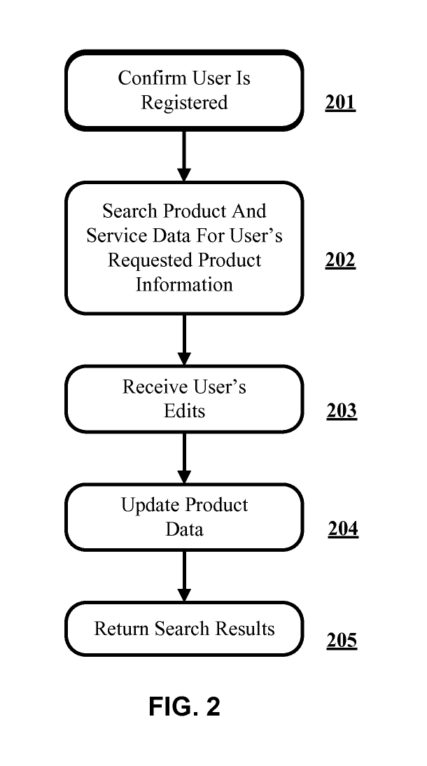

FIG. 2 is a flow chart of exemplary steps for providing requested product data to a user. The steps of FIG. 2 are described with reference to the system components of FIG. 1. It will be understood by one of skill in the art from the description herein that one or more steps can be omitted and/or different components can be utilized without departing from the scope of the disclosed systems and methods.

In step 201, the processor 103 receives a product search request from a user, via network adapter 108. Processor 103 can then determine whether the user is a registered user or is a new user. If the user is a new user, processor 103 can prompt the new user to register before responding to the new user's product search request with product information. Additionally, the system can be configured to respond to the new user's product search request without prompting the new user to register.

In step 202, if the user is registered or if the system is configured to respond without prompting the new user to register, processor 103 searches product data 107 for the user's search request. The product ranking data can be stored in mass storage device 104 or in system memory 112. As noted above, product data 107 can be stored in any of one or more databases known in the art. Examples of such databases comprise, DB2®, Microsoft® Access, Microsoft® SQL Server, Oracle®, mySQL, PostgreSQL, and the like.

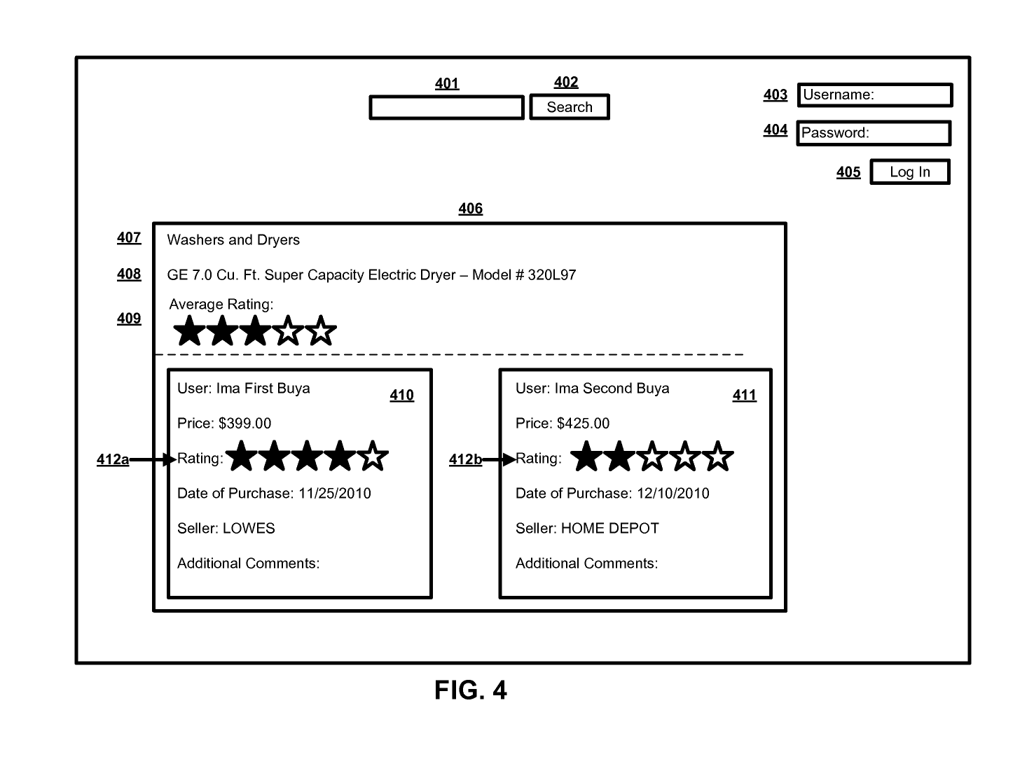

In step 203, if processor 103 determines that product data 107 contains data that matches the user's search request, the data that matches the user's search request is returned to the user, via network adapter 108. If product data 107 does not contain data that matches the user's search request, the processor 103 can prompt the user to create a new product listing page. Additionally, processor 103 can return sponsored or purchased product listing pages to the user, via network adapter 108. Product data 107 can comprise product listing pages (See FIG. 4, described below) comprising different types of information such as purchase prices, product reviews, product experiences, retail locations, instructional videos, maintenance instructions, and any other information users add to the product listing pages. The user can review, edit, or add information to the product listing pages.

In another aspect, product data 107 can comprise user ratings and votes on the quality and accuracy of the information provided to the user in the product listing pages that are provided to the user. Gathering user ratings and votes on the quality and accuracy of the information in the product listing pages can comprise providing a rating system and a voting system for each product listing page. For example, the rating system can allow the user to rate the quality of the information in a first product listing page. The voting system can allow the user to vote on whether the user feels the information in a first product listing page is more helpful and more accurate than the information in a second product listing page.

In step 204, processor 103 receives the data containing the user's edits and updates, via network adapter 108. The user's edits can comprise the information added by the user, the updates to the product listing page, and the user ratings and votes.

In step 205, the user's edits can be stored in mass storage device 104 or in system memory 112. The user's edits can be automatically added to product data 107 or can require approval before the user's edits are added to product data 107.

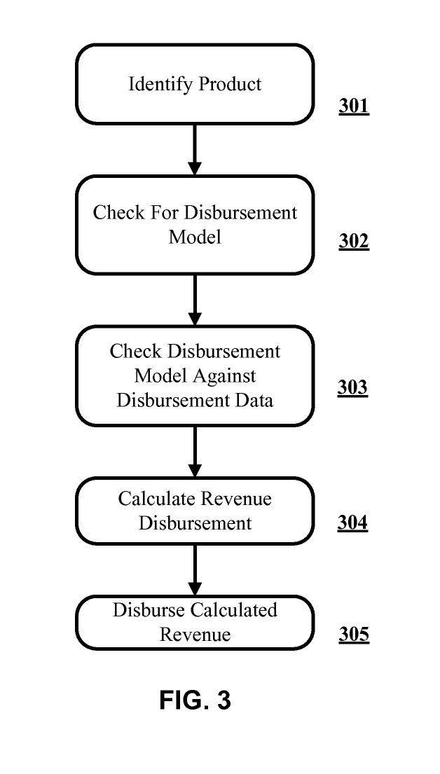

Additionally, the system can track additional data for revenue disbursement (described in FIG. 3, below), resulting in revenue disbursement data. The revenue disbursement data can comprise the number of times a product listing page was viewed, the number of times a product listing page was updated, the dates the product listing page was viewed or any other variable that would be useful for tracking user interest in the product listing page and for disbursing an amount of revenue to users.

FIG. 3 is a flow chart of exemplary steps for determining and disbursing revenue to users. The steps of FIG. 3 are described with reference to the system components of FIG. 1. It will be understood by one of skill in the art from the description herein that one or more steps can be omitted and/or different components can be utilized without departing from the scope of the disclosed systems and methods.

In step 301, processor 103 determines which product listing pages to evaluate and whether advertisement revenue should be disbursed to users. Determining which product listing pages to evaluate and whether advertisement revenue should be disbursed to users can occur in real time, at preset times, or on demand. Advertisement revenue can be generated when users view product listing pages. Additionally, advertisement revenue can be generated when a user purchases a product from a seller's website if the seller's website is linked in the seller's product listing page. For example, advertisement revenue can be generated if a user views a product listing page created by SONY for a SONY PLAYSTATION 3. In another example, the product listing page created by SONY for a SONY PLAYSTATION 3 can contain a link to SONY's website. Additional advertisement revenue can be generated if the user first, travels to SONY's website from the product listing page created by SONY and second, purchases a PLAYSTATION 3.

In step 302, processor 103 determines which revenue disbursement model to use. Selection of the revenue disbursement models can be configured to vary between different product listing pages, can change according to the selection date, or can be uniform across the system. A revenue disbursement model can comprise tracking data to determine an interest level in each product listing page, resulting in interest level data. The interest level data can be used to determine a reward for users that generate a sufficient level of interest in the products. The system can determine whether a sufficient level of interest has been generated by tracking user activity and monitoring a predetermined interest level threshold for each product listing page. The system can determine the level of interest by monitoring and tracking which users create product listing pages that generate the most interest. For example, the system can monitor a product listing page to track different types of data, which can include: which user created the listing; the number of views per minute, day, week, month, or any measure of time; the number of outside websites that link to the specific product listing page; the number of other users who rate the listing; a rating other users assign the product listing page; and any other method of data tracking used to determine consumer interest.

In step 303, processor 103 compares the interest level data against the selected disbursement model from step 302. If the level of interest for the product listing page surpasses the interest level threshold for the product listing page the system will calculate the amount of revenue to be disbursed to the user that generated the most interest.

In step 304, processor 103 determines an amount of the revenue to be disbursed to the user that generated the most interest. The amount of revenue can vary according to predetermined variables about the product in the product listing page. The predetermined variables can comprise the popularity of the product, the time of year, the amount of time the product has been on the market, and any other variable that can be used to determine a product's popularity. The revenue can be determined based on a percentage of advertisement revenue generated, a flat fee amount, or any other amount.

In step 305, processor 103 sends instructions for the determined revenue from step 304 to be disbursed. The disbursement can occur automatically or after a predetermined time. Additionally, the disbursement can comprise mailing a certified check, wiring revenue to the user's bank account, applying the revenue towards future purchases of paid or sponsored product listing pages, or any other method that will allow the user to receive disbursed revenue. In another aspect, processor 103 sends notification of the disbursement of the revenue. Notification of the disbursement of the revenue can comprise an internal message to the user, an e-mail to a user designated account, a mailed notification, or any other method that can be used to notify a user of the disbursement. In an aspect, a user desiring to post information can be required to have an account to qualify to receive advertising revenues. A user can be required to provide information that is not readily obtainable from automatic connections to other websites and web services.

FIG. 4 is an exemplary illustration of a webpage displaying user created product listing pages. The components of FIG. 4 are described with reference to the system components of FIG. 1 and the steps of FIG. 2 and FIG. 3. It will be understood by one of skill in the art from the description herein that one or more components can be omitted and/or different components can be utilized without departing from the scope of the disclosed systems and methods. Further, one skilled in the art will appreciate that the webpage displaying user created product listings can be accessed, viewed, and edited via smart phones, personal digital assistants (PDAs), personal computers (PCs), or any other acceptable computing devices.

Text box 401 represents a text entry field where a user can enter text representing a search query describing a product (see FIG. 2, 202). Search button 402 allows the user to submit the search query. However, the system can be configured to receive the search query without using search button 402. Any acceptable method of data entry can be used to send the search query to processor 103.

Text boxes 403 and 404 represent a text entry field where a user can enter text representing a username and a password. These text entry fields can be utilized to confirm a user is registered with the system (see FIG. 2, 201). Login button 405 allows the user to submit a username and password. However, the system can be configured to receive the login information without using login button 405. Any acceptable method of data entry can be used to send the login information to processor 103.

Product listing page 406 is an exemplary embodiment of a product listing page which displays the results of the user's search query for a specific product. The product listing page can be created by users and can be used to display information to other users. The product listing page can be organized by category listing 407. Category listing 407 can comprise any consumer goods, such as consumer electronics, appliances, tools, home furnishings, automobiles, and any other products or services a consumer might wish to research, or other services. For example, product listing page 406 falls within the “Washers and Dryers” category. Category listings can be determined by an administrator, or can be automatically generated. Product name 408 lists an example product, “GE 7.0 Cu. Ft. Super Capacity Electric Dryer—Model #320L97.” Product name 408 can be entered when the user creates the listing or can be automatically assigned. Product rating 409 allows users to quickly assess other user's views of the product. Product rating 409 can comprise stars, numbers, symbols, or any other text or image that can convey other user's overall opinion of the product.

User listings 410 and 411 are examples of product information that has been added by individual users. Individual listings 410 and 411 contain different data fields that give other users information about the product. These data fields can comprise the user's ID, the date of the individual listing's creation, the user's purchase price, the user's date of purchase, the seller, the user's comments, and any additional information that other users can find useful when reviewing product listing pages. These data fields can be used to determine types of data mining. For example, the date of the individual listing's creation can be used to see how new an individual listing is.

Additionally, user listings 410 and 411 contain individual listing rankings 412a and 412b which can be used to convey information about user listings 410 and 411. The individual listing rankings 412a and 412b can be stars, numbers, symbols, text, or any other figures that can convey the community's overall opinion on the individual listings. These rankings can be used to determine when an interest level threshold has been surpassed so that a revenue sharing model can be implemented (see FIG. 3, 304, discussed above).

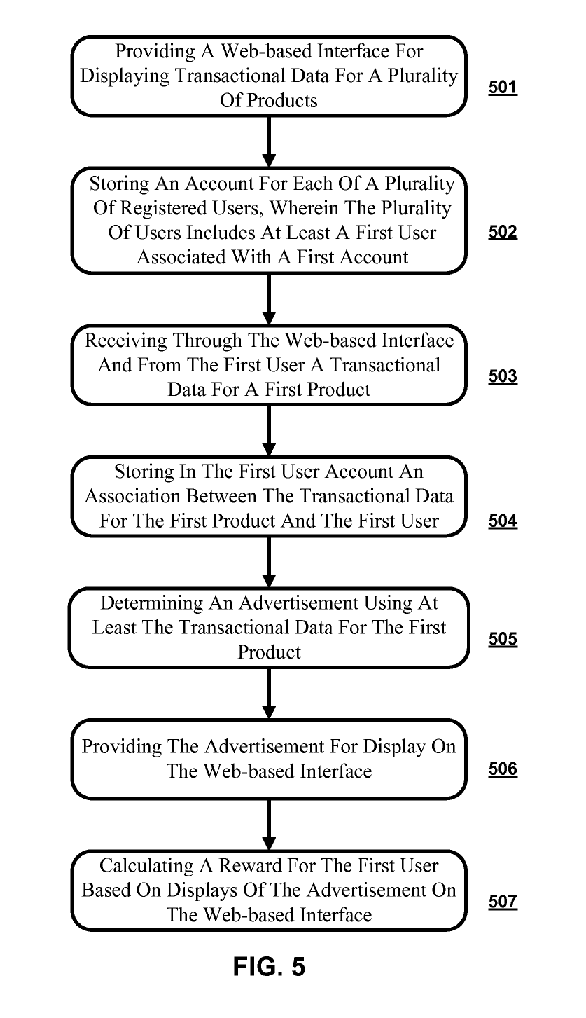

FIG. 5 is a flow chart of exemplary steps for aggregating transactional data associated with consumer products. The steps of FIG. 5 can be described with reference to the system components of FIG. 1. It will be understood by one of skill in the art from the description herein that one or more steps can be omitted, one or more steps can be performed in a different order, and/or different components can be utilized without departing from the scope of the disclosed systems and methods.

First, a web-based interface, such as shown in FIG. 4, can be provided 501 for displaying transactional data for a plurality of products. As used herein, the term “product” refers to products, services, and any combination thereof. For example, transaction data for a product can include at least one of price advertised, price paid, price discount, sale time, sale location, seller identification, product identifier, product manufacturer, and payment type. Accordingly, transactional data can comprise data generated directly by a sales transaction, such as sales price, discount(s), and number of items purchased as well as data derived therefrom, such as an average sales price for a product given a certain time period. Transactional data in any embodiment of the present invention can comprise any information that is directly, or indirectly, created or generated as a result of a sales transaction for a product. The web-based interface can be provided in any embodiment by one or more web servers, such as by an Apache web server.

Second, an account can be stored 502 for each of a plurality of registered users, wherein the plurality of users includes at least a first user associated with a first account. The account can be stored 502 on any suitable computer storage device, including system memory 112 and/or mass storage device 104. Registered users, for example, can access the web-based interface and their accounts using Username 403 and Password 404 information.

Third, a transactional data for a first product can be received 503 through the web-based interface and from the first user. The transactional data can be received by a client device of the user, for example, using a network adapter 108.

Fourth, an association can be stored 504 in the first user account between the transactional data for the first product and the first user. The association can be stored 504 on any suitable computer storage device, including system memory 112 and/or mass storage device 104. In further embodiments, the association can be stored in a database in a computer 101.

Fifth, an advertisement can be determined 505 using at least the transactional data for the first product. The advertisement can be determined using the processor 103 of FIG. 1. The advertisement of any embodiment can comprise any type of advertisement. The advertisement of embodiments of the present invention can comprise one or more of text, an image, a series of images (including video), and/or a sound. For example, the advertisement can comprise an image or video ad for YOUTUBE, an image or video ad for a smart-TV or a ROKU, for example. Accordingly, the advertisement can comprise a banner advertisement rendered on the user interface of a computing device, such as the device illustrated in FIG. 1, for example.

Sixth, the advertisement can be provided 506 for display on the web-based interface of a client device. In a preferred embodiment, the advertisement is provided 506 for display by a web browser on a client device.

Seventh, a reward can be calculated 507 for the first user based on displays of the advertisement on the web-based interface. The reward can be calculated 507 using any suitable manner, such as by using the embodiments disclosed with respect to FIG. 3. By way of further example, a reward for the first user can be calculated based a number of times the advertisement is displayed on the web-based interface. The reward can also be calculated for the first user based a number of sales associated with the advertisement. The reward can further be calculated based a number of clicks on the advertisement, for example.

The method of FIG. 5 can further comprise the step of experiencing the advertisement by a third-party using a client device. In various embodiments, the third-party can be a second user that is associated with a second account. The client device of any embodiment can comprise the computer 101 of FIG. 1 at least one of a personal computer, notebook, netbook, tablet, thin client, smart phone, cell phone, and/or personal digital assistant.

An advertisement can be determined in any suitable manner in embodiments of the present invention. For example, with regard to FIG. 5, the step of determining an advertisement 505 can comprise determining an advertisement using at least the transactional data for the first product and a second transactional data for the first product. In addition and/or in the alternative, for example, the step of determining an advertisement 505 can comprise determining an advertisement using at least the transactional data for the first product and a transactional data for a second product. The second transactional data for the first product can be supplied by a second user associated with a second account. Similarly, the transactional data for the second product can supplied by a second user associated with a second account. In further embodiments, determining an advertisement 505 can comprise determining an advertisement using transactional data received through the web-based interface for a plurality of products.

Additional rewards can be calculated in embodiments of the present invention and can be useful, for example, to further incentivize user and/or third-party behavior. For example, the embodiment of FIG. 5 can further comprise calculating a reward for the second user based of displays of and/or interactions with the advertisement on the web-based interface. The reward of any embodiment can comprise a fractional reward that is divided among a plurality of registered users, such as between the first user and the second user.

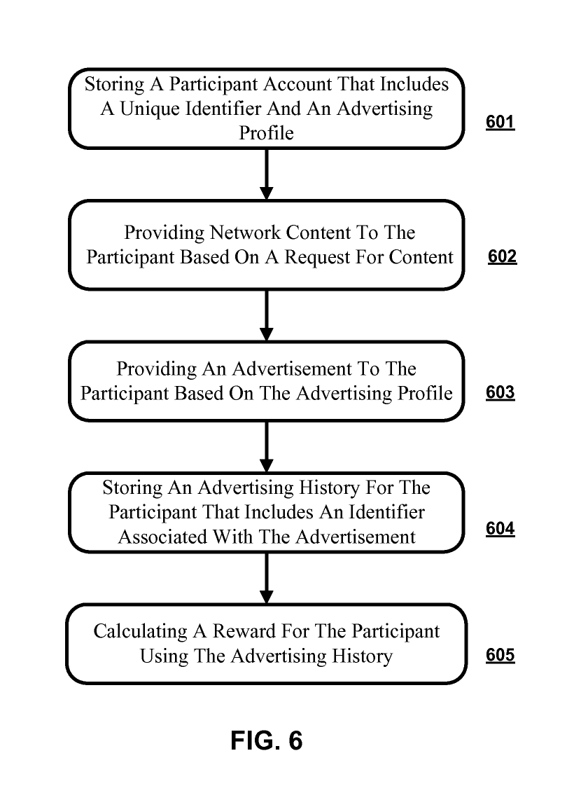

Further embodiments of the present invention can provide methods, computer program products, and systems for providing a network advertising program that rewards consumer participation. The embodiment of FIG. 6 shows one particular, but non-limiting, computer-implemented method of the present invention for providing a novel network advertising program that rewards consumer participation. The steps of FIG. 6 can be described with reference to the system components of FIG. 1. It will be understood by one of skill in the art from the description herein that one or more steps can be omitted, one or more steps can be performed in a different order, and/or different components can be utilized without departing from the scope of the disclosed systems and methods.

First, a participant account can be 601 stored, with the participant account including a unique identifier and an advertising profile. The participant account can be stored 601 on any suitable computer storage device, including system memory 112 and/or mass storage device 104. The participant account can, for example, comprise a flat file or one or more records in a database. The unique identifier can comprise any information useable to uniquely identify a participant, such as at least one of a user name, e-mail address, account number, or phone number. In further embodiments, the participant account can be stored at an account server 803 or other device on the network. The advertising profile can include demographic information related to the participant, and demographic information can be provided by at least one of the participant or a third-party. Additionally, the method of FIG. 6 can comprise registering the participant by receiving at least a user identifier associated with the participant.

The account server 803 can be described with reference to the computer 101 of FIG. 1, and the account server 803 can include a SQL-compatible database, for example, for storing participant accounts. The database of any embodiment of the present invention can comprise a parallel database of the type described in U.S. Pat. No. 7,177,874, entitled “System and Method for Generating and Processing Results Data in a Distributed System”, which is herein incorporated by reference in its entirety for all useful purposes.

Second, as shown in FIG. 6, network content can be provided 602 to the participant based on a request for content. The request for content can comprise at least one of a request for a web page, a file, audio, video, text, sound, streaming content, and any combination thereof. In further embodiments, the network content can be provided by a content server 801 or other device on the network. The content server 801 can be described with reference to the computer 101 of FIG. 1, and can be coupled to the network using network adapter 108, for example.

In further embodiments, the step of providing network content 602 can comprise providing network content to the participant based on a request for content from the participant. In other words, the content provided can be the same as the content requested, such as a web page including information about a product. In the alternative, the step of providing network content 602 can comprise providing network content to the participant based on a request for content from a third-party. The third-party can be a second participant associated with a second participant account, or the third-party can be an entity without a participant account.

Third, as shown in FIG. 6, an advertisement can be provided 603 to the participant based on the advertising profile. The advertisement can similarly be sent to and/or received by the participant, for example, using a network adapter 108. In additional embodiments, the step of providing an advertisement 603 can comprise providing an advertisement to the participant using the advertising profile simultaneously with providing 602 the content to the participant.

The advertisement of any embodiment can comprise at least one or more of text, an image, a video, or a sound, and any combination thereof. The advertisement can be experienced by the participant using a client device. Thus, for example, the advertisement can comprise a clickable banner advertisement rendered by the client device. In further embodiments, the advertisement can be provided by an advertising server 802 or other device on the network. The advertising server 802 be described with reference to the computer 101 of FIG. 1, and can be coupled to the network using network adapter 108, for example.

In further embodiments, one or more advertising topics can be selected by the participant and stored, for example, in the advertising profile. The step of providing an advertisement 603 can thus comprise providing an advertisement to the participant using the advertising profile and the one or more advertising topics. By way of example, the participant could indicate a topic of washers and dryers 407 that corresponds to a product listing category in FIG. 4.

Fourth, as shown in FIG. 6, an advertising history can be stored 604 for the participant that includes an identifier, such as a unique number, associated with the advertisement. The advertising history can be stored 604 on any suitable computer storage device, including system memory 112 and/or mass storage device 104. Accordingly, in further embodiments, the step of storing an advertising history 604 can comprise storing an advertising history that includes an identifier associated with the advertisement at an account server 803 on the network.

Any suitable information regarding or derived from the advertisement can be stored in the advertising history. For example, the advertising history can comprise at least one an identifier for one or more advertisements provided to the participant, the length of time the one or more advertisements were experienced by the participant, and whether the one or more advertisements resulted in a subsequent search or click-through of the one or more advertisements by the participant.

Fifth, a reward can be calculated 605, for example, for the participant using the advertising history. The reward of any embodiment can comprise anything of value, such as one or more of money, points, credits, or one or more tangible or intangible items.

In various embodiments, the reward can be calculated 605 by a processor such as processor 103 of FIG. 1. Thus, the reward can be calculated by the processor 103 of an account server 803. In further embodiments, the step of calculating a reward 605 can comprise calculating a reward for the participant using the advertising history of the participant by using a percentage of corresponding advertising revenues generated by the advertising history.

In additional embodiments based on the embodiment of FIG. 6, the advertising profile can be updated based on the advertisement provided to the participant. For example, the advertising profile can be updated by adding information based on an interaction, such as a click-through, of the participant with the advertisement.

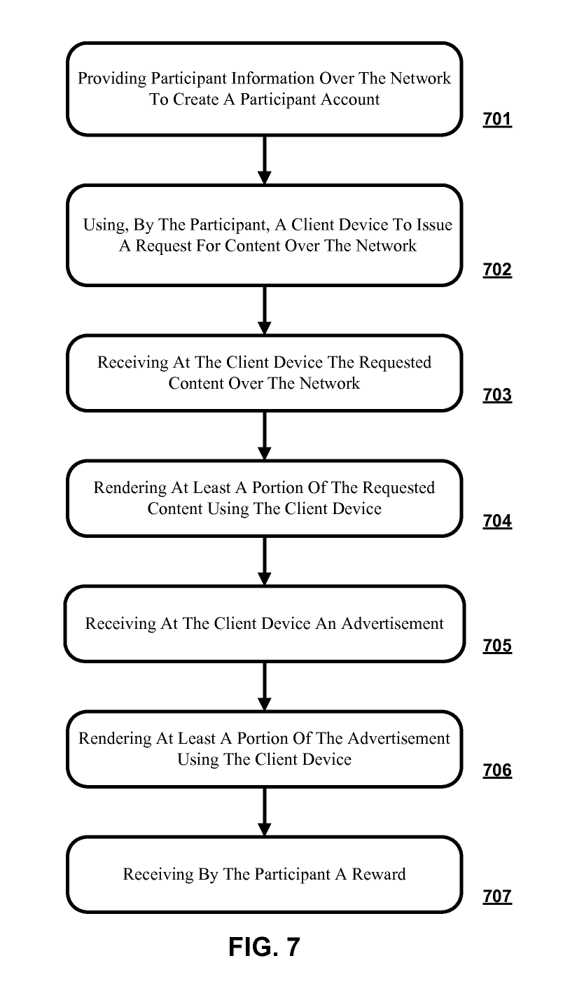

Another embodiment of the present invention provides a method and computer program product for a network advertising program that rewards a participant. One such embodiment is illustrated by FIG. 7. The steps of FIG. 7 can be described with reference to the system components of FIG. 1. It will be understood by one of skill in the art from the description herein that one or more steps can be omitted, one or more steps can be performed in a different order, and/or different components can be utilized without departing from the scope of the disclosed systems and methods.

First, a participant provides 701 information over the network to create a participant account. The participant account can be associated with one or more of a unique identifier, an advertising profile, and an advertising history, and can be stored at an account server 803. Second, the participant uses 702 a client device (including but not limited to client device 804), such as a personal computer, smart-phone, tablet, or any device described with respect to FIG. 1, for example, to issue a request for content over the network, such as a request for a web page. Third, the client device receives 703 the requested content over the network. The requested content can be provided by a content server 801. Fourth, at least a portion of the requested content is rendered 704 on the client device, such as by displaying the requested content in a web browser and/or application on the client device. Fifth, the client device receives 705 an advertisement selected using at least one of the request for content and the advertising history. The advertisement can be provided by an advertising server 802. Sixth at least a portion of the advertisement is rendered 706 using the client device, such as by using display adapter 109. The requested content and the advertisement can be simultaneously rendered, such as by being simultaneously rendered in the same web browser or application window. Finally, the participant receives 707 a reward, for example, based on at least one of the advertising history, the advertisement, and the participant's interaction with the advertisement (such as click-through and/or subsequent product purchase). The participant can then receive a notification of the issued reward on the client device, such as by displaying a number of points, credits, and/or dollars on a display of the client device, for example.

In additional embodiments of the methods, systems, and computer program products of the present invention, the network advertising program can utilize in whole or in part an application or “app” installed on a mobile device such as a smart phone (e.g. an IPHONE or ANDROID phone, for example). By way of example only, the participant account can be created, accessed, updated, and/or modified using the app, the request for content (such as a request for a web page or other content) can be made using the app, the advertisement can be received and/or displayed by the app, and/or the reward can be displayed by the app.

Additional embodiments of the present invention, including the methods, systems, and computer program products described herein can include the step of receiving notification at the client device of an additional reward that is based on a second advertising history associated with a second participant. Similarly, notification can be received at the client device of an additional reward that is based on a reward issued to a second participant.

In yet further embodiments, notification can be received at the client device of a reward issued to a second participant that is based on the advertising history. Notification can also be received at the client device of a reward issued to a second participant that is based on the reward. In other words, one participant can receive rewards based on the actions of a plurality of other participants, thereby providing significant and compound incentives for participating in the network advertising program.

In further embodiments of the methods, systems, and computer program products of the present invention, such as those described with respect to FIGS. 2-8, the advertisement, related product information, transactional data, advertising history, and/or rewards can be shared with and/or displayed for or to the participant's network contacts. A network contact can comprise a person or entity that is linked to and/or associated with the participant through one or more web pages, social networking web sites, or lists such as FACEBOOK, OUTLOOK, TWITTER, GMAIL, YOUTUBE, YELP!, or TUMBLR, for example.

Accordingly, in one embodiment, the participant can cause the network advertisement to be provided to or displayed by a network contact, such as to a FACEBOOK “friend.” For one example, the participant's received advertisement can be displayed on the FACEBOOK page of his “friend,” thereby promoting both further interaction with the advertisement and participation. Moreover, the network contact can be associated with a second participant account as described herein, for example, or can be a third-party. Associating a network contact with a participant account provides numerous additional advantages to embodiments of the present invention. For example, a reward can be issued to the participant as a result of a reward being issued to the second participant (such as a FACEBOOK friend). Likewise, a reward can be issued to the second participant as a result of a reward being issued to the participant. In other words, both participants can receive additional, compound rewards based on the participation of the other participant.

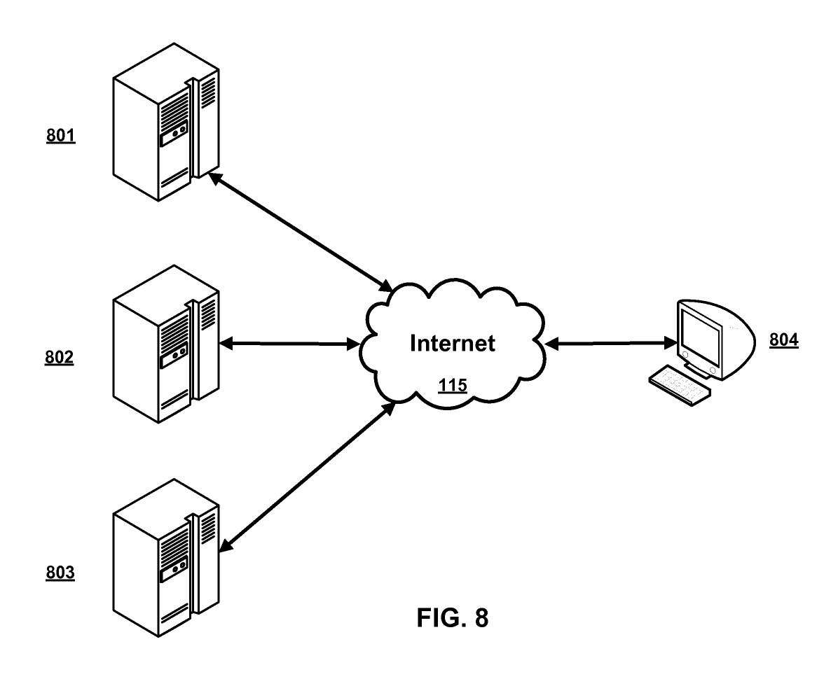

Additional embodiments of the present invention provide systems relating to network advertising programs that reward consumer participation. One such system, by way of example only, is shown in FIG. 8. The steps and/or elements of FIG. 8 can be described with reference to the system components of FIG. 1. It will be understood by one of skill in the art from the description herein that one or more steps can be omitted, one or more steps can be performed in a different order, and/or different components can be utilized without departing from the scope of the disclosed systems and methods.

The embodiment of FIG. 8 includes three servers, including a content server 801, an advertising server 802, and an account server 803, with each server in communication with a client 804 over a network 115 such as the Internet. Each of the content server 801, advertising server 802, and account server 803 can comprise a separate physical server that embodies the computer 101 of FIG. 1. In the alternative, two of more of the content server 801, advertising server 802, and account server 803 can comprise software or a process executing on the same physical or virtualized server. The content server 801 can be configured to provide content to a participant based on a request for content from the client 804. Similarly, the advertising server 802 can be configured to provide an advertisement to the participant 804 based on an advertising profile. Two or more of the content server 801, the advertising server 802, and the account server 803 can reside on the same local area network, or all three servers can reside on different local area networks.

The account server 803 can be configured, such as by a programmed processor 103, to perform one or more steps, including storing a participant account that includes a unique identifier and the advertising profile, storing an advertising history for the participant that includes an identifier associated with the advertisement, and calculating a reward to the participant using the advertising history. The account server 803 can be further configured to register the participant by receiving at least a user identifier associated with the participant. In various embodiments, the account server 803 can also be configured to update the advertising profile based on the advertisement provided to the participant. The advertising profile can be updated, for example, by adding information derived from an interaction of the participant with the advertisement.

The advertisement provided by the advertising server 802 can be experienced by the participant using a client device 804. The client device can comprise at least one of a personal computer, notebook, netbook, tablet, thin client, smart phone, smart TV, cell phone, and/or personal digital assistant in embodiments of the present invention.

While the invention has been described in detail in connection with specific embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. Specific embodiments should be taken as exemplary and not limiting.

We claim:

1. A computer-implemented method for providing a network advertising program that rewards consumer participation, the method comprising:
a. storing a participant account that includes a unique identifier and an advertising profile;
b. providing network content to the participant based on a request for content;
c. providing an advertisement to the participant based on the advertising profile;
d. storing an advertising history for the participant that includes an identifier associated with the advertisement; and
e. calculating a reward for the participant using the advertising history.

2. The method of claim 1, further comprising the step of updating the advertising profile based on the advertisement provided to the participant.

3. The method of claim 2, wherein the advertising profile is updated by adding information based on an interaction of the participant with the advertisement.

4. The method of claim 1, wherein the request for content comprises a request for a web page.

5. The method of claim 1, wherein the step of providing network content comprises providing network content to the participant based on a request for content from the participant.

6. The method of claim 1, wherein the step of providing network content comprises providing network content to the participant based on a request for content from a second participant associated with a second participant account.

7. The method of claim 1, wherein the step of providing an advertisement to the participant comprises providing an advertisement to the participant using the advertising profile simultaneously with providing the content to the participant.

8. The method of claim 1, wherein the advertisement comprises at least one or more of text, an image, a video, or a sound.

9. The method of claim 1, wherein the step of calculating a reward for the participant comprises calculating a reward for the participant using the advertising history of the participant by using a percentage of corresponding advertising revenues generated by the advertising history.

10. The method of claim 1, further comprising selecting one or more advertising topics by the participant.

11. A computer-implemented method for a network advertising program that rewards a participant, the method comprising:
a. providing participant information over the network to create a participant account that is associated with a unique identifier, an advertising profile, and an advertising history;
b. using, by the participant, a client device to issue a request for content over the network;
c. receiving at the client device the requested content over the network;
d. rendering at least a portion of the requested content using the client device;
e. receiving at the client device an advertisement that was selected using at least one of the request for content and the advertising history;
f. rendering at least a portion of the advertisement using the client device; and
g. receiving by the participant a reward based on at least one of the advertisement and the advertising history.

12. The method of claim 11, wherein the client device simultaneously receives and renders the requested content and the advertisement.

13. The method of claim 11, further comprising the step of receiving by the participant an additional reward based on activity of a second participant.

14. The method of claim 11, further comprising the step of receiving by the participant an additional reward as a result of a reward issued to a second participant.

15. The method of claim 11, further comprising the step of receiving notification at the client device of a reward issued to a second participant, wherein the reward issued to the second participant is based on the advertising history.

16. The method of claim 11, further comprising the step of receiving notification at the client device of a reward issued to a second participant, wherein the reward issued to the second participant is based on the reward.

17. The method of claim 11, further comprising the step of causing the network advertisement to be provided to a network contact of the participant.

18. The method of claim 17, wherein the network advertisement is displayed on a social networking web page associated the network participant.

19. The method of claim 11, wherein a reward is issued to the second participant as a result of the reward being issued to the participant.

20. The method of claim 11, further comprising the step of selecting one or more advertising topics by the participant.
